(19) United States
(12) Patent Application Publication
(10) Pub. No.: US 2003/0047725 A1
(43) Pub. Date: Mar. 13, 2003

(54) Auxiliary device for moving vehicles in mired situations

(76) Inventor: Pedro Enrique Borgoglio, La Plata (AR)

Correspondence Address: DARBY & DARBY P.C., P. O. BOX 5257, NEW YORK, NY, 10150-5257, US

(21) Appl. No.: 10/216,542

(22) Filed: Aug. 9, 2002

(30) Foreign Application Priority Data
Aug. 9, 2001 (AR) P010103828

(51) Int. Cl. B66F 3/00

(52) U.S. Cl. 254/213

(57) ABSTRACT

An auxiliary device for moving vehicles in soft terrain, the device operating in a manner like a winch but is driven by a drive wheel of the vehicle, the auxiliary device comprising a winding body controllably connected to the driven wheel and a cable for winding around the winding body and for fixing to a fixed object in the terrain.

### BACKGROUND OF THE INVENTION

1. Field of the Invention

The present invention relates to an auxiliary device for removing vehicles out of mires or any other mired situation wherein a vehicle may be mired in mud, sand, snow, and even in upgrade sloped ways, wherein the vehicle is removed from the mire or move up along the slope by connecting the device to a fixed object in the terrain wherein the device may operate like a winch.

2. Description of the Prior Art

It is well known that vehicles, even 4×4 vehicles become mired in soft terrain like mud, sand, etc. This is because the active wheels, that is the driven wheels rotate without the capacity of gripping the terrain to move the vehicle. It is hard to move the vehicle in these situations even when many efforts are made by removing part of the mud under the wheels, placing tree branches under the wheels, etc. Generally it is necessary to receive help from an additional vehicle circulating on a firm terrain. The additional vehicle is connected to the mired vehicle by a cable and the mired vehicle is towed by the additional vehicle out from the soft terrain.

A well know device for moving mired vehicles are the chains that must be installed around the drive wheels, which chains will improve the gripping of the wheels in the soft terrain. The chains must be installed in the wheels before the vehicle enters the soft terrain and must be removed afterwards in a general very dirty condition, particularly if the soft terrain was mud. This is of course very uncomfortable. The situation is worst if, inadvertently, the vehicle enters the soft terrain without installing the chains.

Another broadly employed device is the winch consisting of an electric device that must be fixed, generally permanently installed, in a firm front part of the vehicle. The winch basically consists of an electric motor, a reel actuated by the electric motor and a cable. In a mired situation, the cable is unwound from the reel and an end of the cable is fixed to a fixed object, a tree for example. Then, the electric motor is activated in order to wind the cable into the reel and pull the vehicle out from the mud. While this device is effective, the same is quite expensive and occupies an important length of the vehicle that causes, some times, the vehicle can not be accommodated into the garage.

### 3. SUMMARY OF THE INVENTION

It is therefore one object of the present invention to provide an auxiliary device for moving vehicles in soft terrain, the device operating in a manner like a winch but driven by a drive wheel of the vehicle, the auxiliary device comprising a winding body controllably connected to the driven wheel and a cable for winding around the winding body and for fixing to a fixed object in the terrain.

It is still another object of the present invention to provide an auxiliary device for connecting to at least one driven wheel of a mired vehicle for removing the vehicle by connecting the device to a fixed object in a terrain, the device comprising, a cable having a first end for connecting to the device and second opposite end for connecting to the fixed object, a main body having a proximal end and a distal end, with the proximal end of the main body including a connecting plate for connecting the device to the at least one wheel, the connecting plate including at least two orifices receiving corresponding bolts for affixing the device to orifices in the at least one wheel, wherein the distal end of the main body is connected to a winding body having a proximal end connected to the distal end of the main body and a distal end, with a winding portion, defined between said ends of the winding body, for receiving the first end of the cable and winding the cable around the winding portion upon rotation of the at least one wheel when the plate is connected to the at least one wheel.

It is even another object of the present invention to provide a method for removing a vehicle out from a mire by using the above mentioned auxiliary device, the method comprising,

connecting the plate of the main body to the at least one driven wheel of the vehicle by passing the bolts through the at least two orifices of the plate and threading the bolts into corresponding orifices in the at least one driven wheel;

connecting the first end of the cable to the winding portion of the winding body;

connecting the second end of the cable to the fixed object;

driving the vehicle for winding the cable around the auxiliary device in order to move the vehicle out of the mire.

It is a further object of the present invention to provide a complementary auxiliary device for connecting idle wheels to driven wheels of a vehicle in order to convert a simple-traction vehicle into a double-traction vehicle, the device comprising, a main body having a proximal end and a distal end, with the proximal end of the main body including a connecting plate for connecting the device to the at least one wheel, the connecting plate including at least two orifices receiving corresponding bolts for affixing the device to orifices in the at least one wheel, wherein the distal end of the main body is connected to a traction pulley, and further comprising a line forming a loop passing over the two traction pulleys of corresponding complementary auxiliary devices at each side of the vehicle.

The above and other objects, features and advantages of this invention will be better understood when taken in connection with the accompanying drawings and description.

### BRIEF DESCRIPTION OF THE DRAWINGS

The present invention is illustrated by way of example in the following drawings wherein:

FIG. 1 shows a side elevation view of an auxiliary device according to a first embodiment of the invention, ready to be connected to a wheel of a vehicle;

FIG. 2 shows a cross-sectional view of the device of FIG. 1;

FIG. 3 shows a perspective view of the inventive device in an application in a mired vehicle;

FIG. 4 shows a diagrammatic view of another application of the device;

FIG. 5 shows a diagrammatic view of still another application of the device;

FIG. 6 shows a side elevation view of an auxiliary device according to another embodiment of the invention, ready to be connected to a wheel of a vehicle;

FIG. 7 shows a side elevation view of an auxiliary device according to another embodiment of the invention, ready to be connected to a wheel of a vehicle; and

FIG. 8 shows a diagrammatic view of an application of the devices of FIGS. 6 and 7;

### DESCRIPTION OF THE PREFERRED EMBODIMENTS

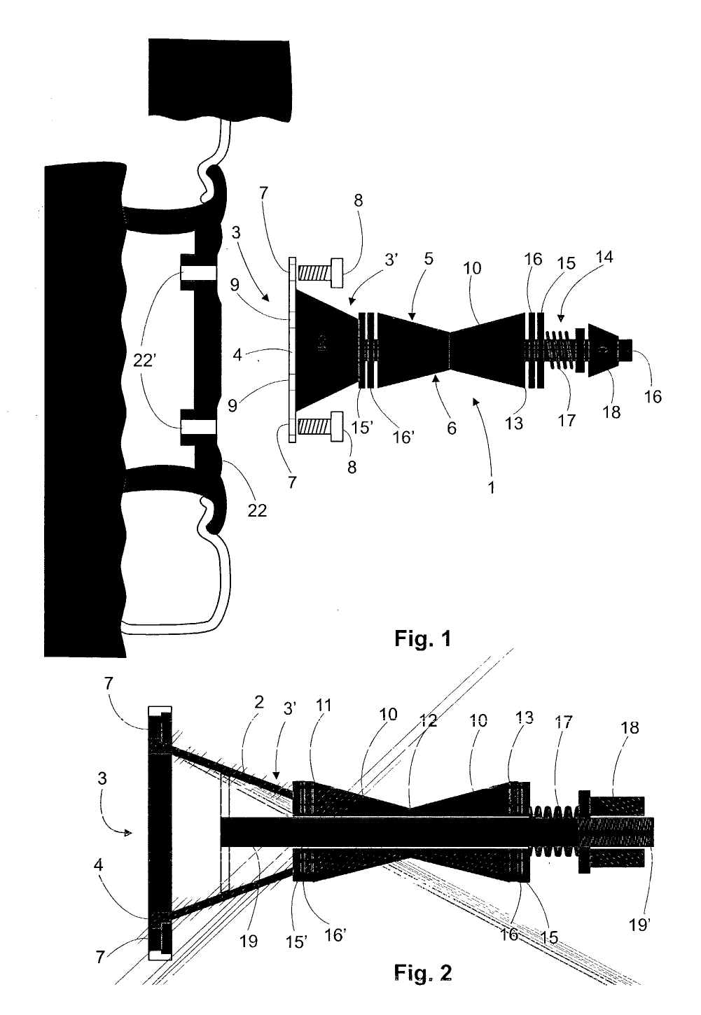

Now referring in detail to the drawings it may be seen from FIGS. 1, 2 and 3 that the auxiliary device of the invention is indicated by the generic reference 1. The auxiliary device is designed for connecting to at least one driven wheel of a mired vehicle, for removing the vehicle from the mired situation by connecting the device to a fixed object in a terrain.

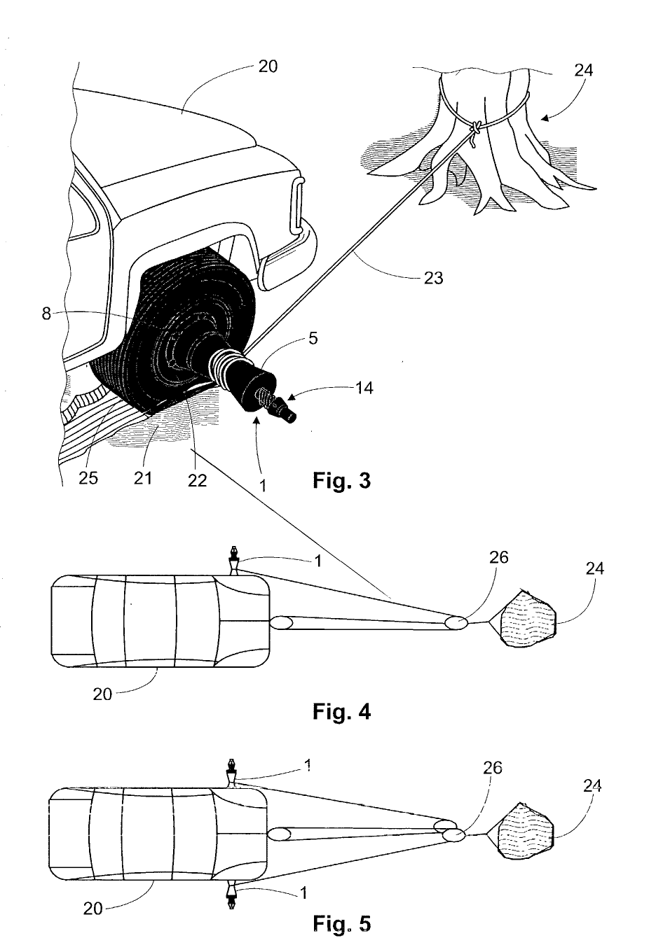

Auxiliary device 1 comprises a main body 2 having a proximal end 3 and a distal end 3′, wherein proximal end 3 includes a connecting plate 4 for connecting the device to at least one drive wheel 22, please see FIGS. 1 and 3, of a vehicle 20. Connecting plate 4 includes at least two orifices, preferably first orifices 7 and second orifices 9, designed for receiving corresponding bolts 8 for affixing the device to orifices 22′ in the wheel. Orifices 22′ may be the conventional orifices provided in a wheel for mounting the wheel in the end of the vehicle shaft. Therefore, when installing the inventive device, at least some bolts of the wheels must be removed in order to place the plate against wheel 22 and insert bolts 8 into such orifices 22′ from which the conventional bolts of the wheel have been removed. In order that plate is perfectly accommodated and coupled against wheel 22, orifices 9 may be provided with a diameter larger than a diameter of orifices 7 in order than the heads of the bolts of the wheel that have not been removed may be accommodated into orifices 9.

Distal end 3′ of the main body is connected to a winding body 5 having a proximal end connected to the distal end of the main body and a distal end. A winding portion 6 is defined between said ends of the winding body, for receiving a first end of a cable 23. Cable 23 is also fixed to a fixed object, such as a tree 24, and when wheel 22 is actuated and rotated, and plate 4 is connected to wheel 22, the cable is wound around the winding portion thus operating like a winch.

Winding body 5 is a revolution body and winding portion 6 has diameter, preferably at a central portion thereof, smaller than a diameter of the proximal and distal ends of the winding body, thus defining a reel 10 with a large diameter 11, 13 at proximal and distal ends of the winding body, and a small diameter 12 at a central portion.

Auxiliary device 1 also comprises a safety disconnection mechanism 14 for disconnecting the winding body from the main body upon an excessive predetermined torque over the winding body when the wheel is rotating and cable 23 is excessively stressed. Safety disconnection mechanism 14 comprises a central shaft 19 that freely and longitudinally extends trough the winding body. Central shaft 19 has a proximal end fixed to the main body in any convenient manner, and a distal end extending out of the distal end of the winding body, with the distal end of the central shaft including an end threaded portion 19′ and a nut 18 is controllably threaded onto the threaded portion of the distal end of shaft 19. A compression spring 17 is mounted over the distal end of the shaft and is retained between nut 18 and a first friction coupling mechanism 15, 16, at the distal end of the winding body. A second friction coupling mechanism 15′, 16′, is also located at the proximal en of the winding body.

The first friction coupling mechanism comprises a pressure plate 15 freely mounted over the distal end of the shaft and a friction plate 16 freely mounted over the shaft and located between the pressure plate and the distal end of the winding body. The second friction coupling mechanism comprises a pressure plate 15′ freely mounted over the proximal end of the shaft and fixed to he main body, and a friction plate 16′ freely mounted over the shaft and located between pressure plate 15′ and proximal end 11 of the winding body.

During use and according to another aspect of the invention, a method is also provided for removing a vehicle out from a mire by using the device of the invention, as it is illustrated in FIG. 3. Upon a mired situation, device 1 is installed in a drive wheel 22 by connecting the plate of the main body to the driven wheel of the vehicle, as it was previously explained. The first end of cable 23 is connected to the winding portion of the winding body and the second end of the cable is fixed to tree 24, as illustrated. It is obvious that this sequence may be inverted as desired. Then, the vehicle is started on in order to cause drive wheel 22 to rotate as indicated by the arrow in order to wind the cable around the winding body and thus operate like a winch without the need of an extra electric motor but using the own power of the vehicle. Nut 18 is rotated in order to compress spring 17 with a pressure enough to keep plates 15, 15′ and 16, 16′ sufficiently connected by friction with the distal and proximal ends of the winding body. The pressure exerted spring 17 under the action of nut 18 will be regulated in order that the cable resist a reasonable stress enough to move the vehicle in the soft terrain and for avoiding any excessive stress that could lead to the cable breaking with the associated dangerous effects that this may cause.

For more complicated mired situations, auxiliary pulleys 26 are also provided by the invention. In the event that the fixed object is not available just in from of the mire vehicle, one or more pulleys 26 may be employed as illustrated in FIG. 4, in order to obtain a better and uniform distribution of the stresses independently of the angle formed by a line between the vehicle and the fixed object.

Another application of pulleys 16 is illustrated in FIG. 5 wherein the vehicle is mired in an excessively soft terrain and the force necessary to move the vehicle is very important. Under this situation, two auxiliary devices 1 are connected to the vehicle, one to each front wheel, or any other drive wheels, and the pulleys are combined as illustrated to multiply the force and move the vehicle.

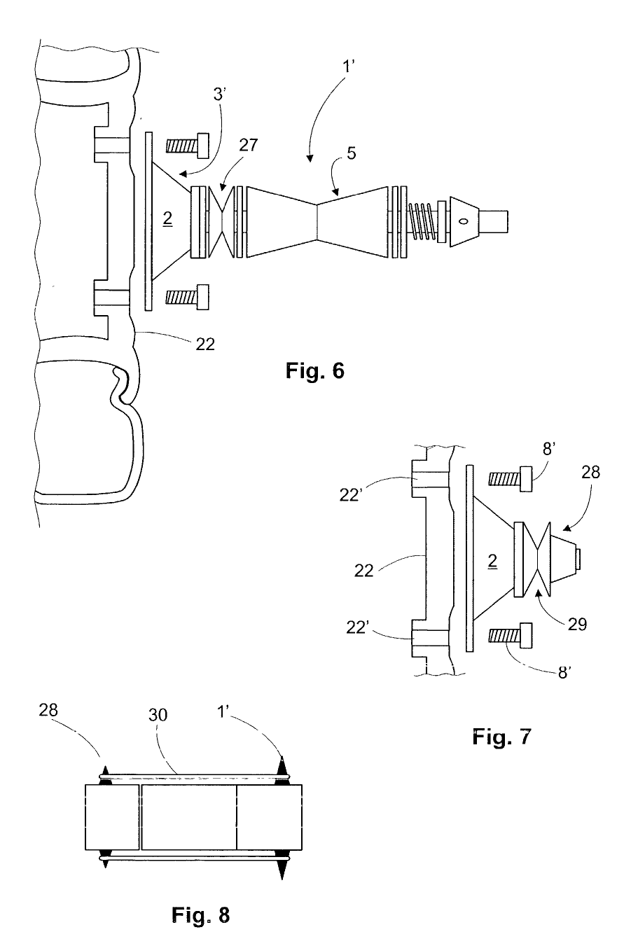

According to another application also provided by the invention, a 4×2 vehicle may be converted into a 4×4 vehicle, that is a vehicle with traction power in the four wheels. For this purpose, the auxiliary device of the invention, as illustrated in FIG. 6, indicated now with general reference 1′, comprises all the components of the device 1 but is provided with a traction pulley 27, preferably arranged between the distal end of main body 2 and the proximal end of winding body 5. The same safety disconnection mechanisms 14 illustrated in FIGS. 1, 2, may be employed in this embodiment, as generically shown in FIG. 6. According to this application, one auxiliary device 1′ is installed in one drive wheel, for example front wheel 22, and another device 1′ is installed in the other idle, that is non drive, wheel at the same side of the vehicle. Then, a transmission line 30 is passed over the pulleys 27 of both devices 1′ in order to transmit to the rear wheel the power from the front wheel. Transmission line may be any appropriate line such as a belt, a chain, etc.

Also according to another alternative of the invention, device 1′ may be used in combination with a complementary auxiliary device 28, shown in FIG. 7, for connecting idle wheels to driven wheels of a vehicle in order to convert a simple-traction vehicle into a double-traction vehicle.

Device 28 comprises a main body 2′ having a proximal end and a distal end, with the proximal end of the main body including a connecting plate, like plate 4 of device 1, for connecting the device to the at least one wheel, the connecting plate including at least two orifices receiving corresponding bolts for affixing the device to orifices in the at least one wheel, wherein the distal end of the main body is connected to a traction pulley 29, Pulley 29 is designed to receive transmission line 30 for use as explained above.

While preferred embodiments of the present invention have been illustrated and described, it will be obvious to those skilled in the art that various changes and modifications may be made therein without departing from the scope of the invention as defined in the appended claims.

We claim:

1. Auxiliary device for connecting to at least one driven wheel of a mired vehicle, for removing the vehicle from the mired situation by connecting the device to a fixed object in a terrain, the device comprising, a cable having a first end for connecting to the device and second opposite end for connecting to the fixed object, a main body having a proximal end and a distal end, with the proximal end of the main body including a connecting plate for connecting the device to the at least one wheel, the connecting plate including at least two orifices receiving corresponding bolts for affixing the device to orifices in the at least one wheel, wherein the distal end of the main body is connected to a winding body having a proximal end connected to the distal end of the main body and a distal end, with a winding portion, defined between said ends of the winding body, for receiving the first end of the cable and winding the cable around the winding portion upon rotation of the at least one wheel when the plate is connected to the at least one wheel.

2. The device of claim 1, wherein the at least two orifices of the plate comprise two first orifices receiving the bolts and at least one second orifice having a diameter larger than a diameter of the first orifices.

3. The device of claim 1, wherein the winding body is a revolution body with the winding portion thereof having a diameter smaller than a diameter of the proximal and distal ends of the winding body.

4. The device of claim 1, further comprising a safety disconnection mechanism for disconnecting the winding body from the main body upon an excessive predetermined torque over the winding body.

5. The device of claim 1, wherein the safety disconnection mechanism comprising a central shaft freely extending trough and along the winding body, the central shaft having a proximal end fixed to the main body and a distal end extending out of the distal end of the winding body and including an end threaded portion, a nut threaded onto the threaded portion and a compression spring passing over the distal end of the shaft and retained between the nut and a first friction coupling mechanism at the distal end of the winding body.

6. The device of claim 5, further comprising a second friction coupling mechanism, wherein the first friction coupling mechanism comprises a pressure plate passing over the distal end of the shaft and a friction plate passing over the shaft and located between the pressure plate and the distal end of the winding body, and the second friction coupling mechanism comprises a pressure plate passing over the proximal end of the shaft and fixed to he main body, and a friction plate passing over the shaft and located between the pressure plate fixed to the main body and the proximal end of the winding body.

7. The device of claim 1, further comprising a traction pulley between the main body and the proximal end of the winding body.

8. A complementary auxiliary device for use with the auxiliary device of claim 7, for connecting at least one idle wheel to a driven wheel of a mired vehicle in order to convert a simple-traction vehicle into a double-traction vehicle, the device comprising, a main body having a proximal end and a distal end, with the proximal end of the main body including connecting plate for connecting the device to the at least one wheel, the connecting plate including at least two orifices receiving corresponding bolts for affixing the device to orifices in the at least one wheel, wherein the distal end of the main body is connected to a traction pulley, and further comprising a line forming a loop passing over the traction pulley of the complementary auxiliary device and over the pulley of the auxiliary device in order to transmit movement from the driven wheel to the idle wheel.

9. The device of claim 8, wherein the line is selected from a group comprising a chain, a belt and a cable.

10. A complementary auxiliary device for connecting idle wheels to driven wheels of a vehicle in order to convert a simple-traction vehicle into a double-traction vehicle, the device comprising, a main body having a proximal end and a distal end, with the proximal end of the main body including a connecting plate for connecting the device to the at least one wheel, the connecting plate including at least two orifices receiving, corresponding bolts for affixing the device to orifices in the at least one wheel, wherein the distal end of the main body is connected to a traction pulley, and further comprising a line forming a loop passing over the two traction pulleys of corresponding complementary auxiliary devices at each side of the vehicle.

11. The device of claim 1, further comprising auxiliary pulleys for connecting to the cable between the winding body and the fixed object.

12. A method for removing a vehicle out from a mire by using the device of claim 1, the method comprising,
connecting the plate of the main body to the at least one driven wheel of the vehicle by passing the bolts through the at least two orifices of the plate and threading the bolts into corresponding orifices in the at least one driven wheel;
connecting the first end of the cable to the winding portion of the winding body;
connecting the second end of the cable to the fixed object;
driving the vehicle for winding the cable around the auxiliary device in order to move the vehicle out of the mire.
